(19) United States
(12) Patent Application Publication
(10) Pub. No.: US 2007/0194034 A1
(43) Pub. Date: Aug. 23, 2007

(54) Device for printing pills, tablets or caplets in a precise manner

(76) Inventor: Vasilios Vasiadis, Astoria, NY (US)

Correspondence Address: WILLIAM COLLARD;COLLARD & ROE, P.C., 1077 NORTHERN BOULEVARD, ROSLYN, NY, 11576, US

(21) Appl. No.: 11/707,422

(22) Filed: Feb. 16, 2007

Related U.S. Application Data
(60) Provisional application No. 60/766,917, filed on Feb. 17, 2006.

(51) Int. Cl. G07F 11/00

(52) U.S. Cl. 221/21

(57) ABSTRACT

A device for printing and sorting elements comprising at least one conveyor for conveying the elements, at least one printer for printing an identifying element on the elements at least one identifying device for identifying whether each element has been properly printed at least one reject chute for optionally rejecting at least one of the elements and at least one accept chute for accepting the remaining elements. The printer can be in the form of at least one but possibly a plurality of inkjet printers which can be assembled in a staggered manner to print an identifying element such as a code or an insignia on each of these elements. The elements can be held in place by an air pump or a vacuum, so that these elements such as pills or tablets do not vibrate when printed. In addition additional air pumps may be used to reject a particular tablet.

### CROSS REFERENCE TO RELATED APPLICATIONS

This application is a non provisional application and hereby claims priority from provisional application Ser. No. 60/766,917 filed on Feb. 17, 2006, titled “DEVICE FOR PRINTING PILLS, TABLETS OR CAPLETS IN A PRECISE MANNER” the disclosure of which is hereby incorporated herein by reference in its entirety.

### BACKGROUND

The invention relates to a device for printing and identifying tablets. Other printing and identifying systems are known. For example, U.S. Pat. No. 5,894,801 to Ackley issued on Apr. 20, 1999, U.S. Pat. Nos. 6,564,710 to Mathea, 5,768,996 issued on Jun. 23, 1998; U.S. Pat. No. 5,655,453 to Ackley issued on Aug. 12, 1997; U.S. Pat. No. 4,655,026 to Wigoda issued on Apr. 7, 1987; U.S. Pat. No. 5,522,512 to Archer et al issued on Jun. 4, 1996; U.S. Pat. No. 6,610,973 to Davis Ill. issued. on Aug. 26, 2003; U.S. Pat. No. 5,558,231 to Weier issued on Sep. 24, 1996 the disclosures of which are hereby incorporated herein by reference.

### SUMMARY

One embodiment of the invention relates to a device for printing and sorting elements comprising at least one conveyor for conveying the elements, and at least one printer for printing an identifying feature or element on the elements. There is at least one printer that can be in the form of an inkjet printer, and at least one identifying device for identifying whether each element has been properly printed. There can be at least one reject chute for optionally rejecting at least one of the elements and at least one accept chute for accepting the remaining elements. The printer can be in the form of at least one, but possibly a plurality of printers such as inkjet printers which can be assembled in a staggered manner to print an identifying element such as a code or an insignia on each of these elements. The elements can be held in place by an air pump or a vacuum, so that these elements such as pills, tablets or caplets do not vibrate when printed. In addition, additional air pumps may be used to reject a particular tablet.

The device can include a computer, wherein this computer is in communication with, and is used to control the conveyor, the printer, or printers and at least one identifying device such as an electric eye or a camera. This device can then be used to identify and print different elements such as pills caplets or tablets. There can also be a tracker or tracking device or system which can be used to track the location of the pills or rows on the conveyor.

The conveyor can include a plurality of plates wherein each plate has a plurality of holes. There can be at least one hole for receiving at least one element, and at least one hole for fastening the plate to an underlying conveyor. The plurality of plates can include at least one receiving section, for receiving the elements, wherein the receiving section extends into and includes at least one of these holes.

This receiving section can be in the form of a first receiving section, and a second receiving section, wherein the first receiving section is sloped down, to initially receive the element and wherein the second receiving section is adapted to retain the element in place.

This first receiving section can be in the form of a ramp shaped section. There can also be a second receiving section which is in the form of a substantially circular indent having a hole disposed in a substantially central region.

These holes can form a fluid conduit between a top surface of the conveyor and an air pump, such that the air pump applies a pressure on these elements in these holes, keeping these elements in these holes. In this case, the term fluid can include air, or any other gas, such as vapor or liquid.

A plurality of different air pumps can be used to apply pressure to the elements or tablets to either stabilize the elements on the conveyor, or to reject the elements from the conveyor.

In this case, there can be at least one identifying device which is in the form of an electric eye or in the form of a camera.

The printer can be in the form of an inkjet printer which has disposable cartridges. The device can include a printer station that includes at least four inkjet printers positioned in a staggered manner.

Some of the advantages of these embodiments include a device having a series of printers in a line for printing multiple elements such as caplets, tablets or pills simultaneously or substantially simultaneously on a conveyor.

Another advantage of this design is that it allows for the rapid analyzation of these elements to determine whether to accept or reject these elements based upon whether these elements have been printed.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a side view of the device;

FIG. 2 is a top view of the device;

FIG. 3 is an end view of the device;

FIG. 4 is a side view of another embodiment of the device;

FIG. 5A is atop view of a plate;

FIG. 5B is atop perspective view of a plate;

FIG. 5C is a side view of the plate shown in FIG. 5A;

FIG. 5D is an end view of the plate;

FIG. 5E is a close up view of a slot for receiving a pill or a tablet;

FIG. 6A is a top view of a first alternative design of printing cartridges;

FIG. 6B is a top view of a second alternative design of printing cartridges;

FIG. 6D is a top view of a third alternative design of printing cartridges;

FIG. 7 is a flow chart for the process for printing pills in a controlled manner.

### DETAILED DESCRIPTION

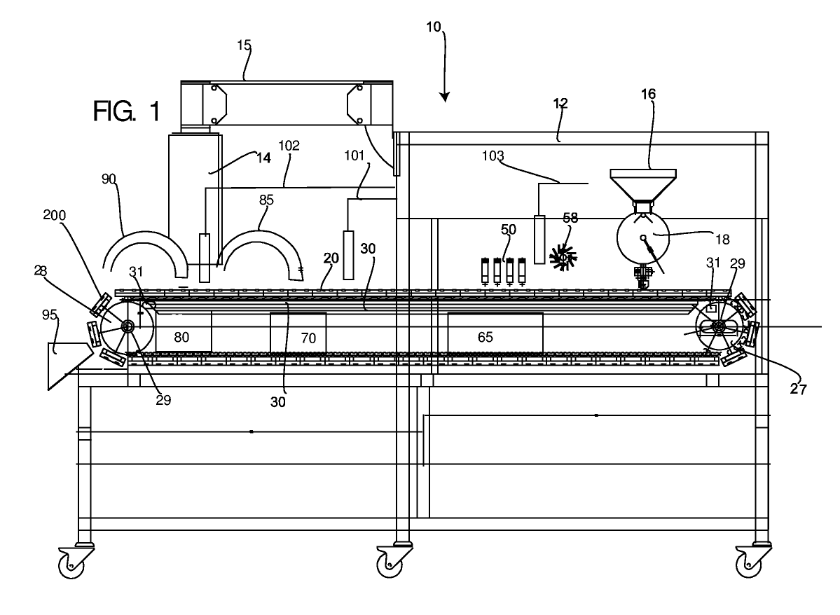

Referring in detail to the drawings, FIG. 1 is a side view of the device 10 which includes a frame 12, and a computer 14, which is rotatably coupled to frame 12 via a rotating arm 15. There is an input chute 16 which is coupled to a dispenser 18. Input chute 16 can be adjusted to fit any type of dispensing machine. The dispenser is used to feed pills, tablets, or other elements onto a conveyor or track 20. In this case, dispenser 18 is shown by way of example, but it can be any known form of dispenser. There is also an air pump or vacuum tray 30 disposed beneath conveyor 20. Air pump or vacuum tray 30 is used to provide a continuous or intermittent force on the pills or tablets resting on the conveyor. For example, this force can be placed intermittently such as just before, during and/or after the tablets are printed. Conveyor 20 runs as an endless conveyor which runs around sprockets 27 and 28 which are disposed at end points of the endless conveyor.

This endless conveyor can be tracked using a tracking system which can include an encoder 29 or an optical or visual tracker 31. Encoder 29 can be disposed or coupled to either shaft of one of the sprockets 27, or 28. In this case, either sprocket can be in the form of a drive sprocket coupled to an associated drive shaft, wherein encoder 29 can be coupled to either one of the shafts, such as either a drive shaft or a driven shaft. This coupling is to calculate the numbers of rotations or fractions of rotations of each shaft.

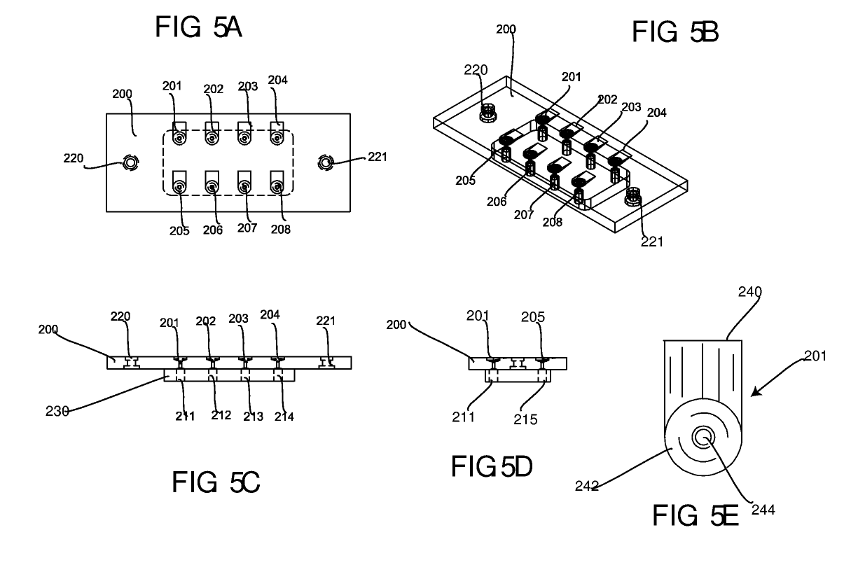

For example, one rotation of either a drive shaft, a driven shaft or the associated sprockets, results in a movement of seven plates 200 (See FIG. 5A) along conveyor 20. In each of the seven plates 20 there can be two rows of pills. Each row of pills can be associated with a hole disposed on a side of a plate extending down from conveyor 20 and perpendicular to plate 200 which can allow a visual or optical tracker 31 which can be in the form of an electric eye having a transmitter and a receiver, to record a movement of a row by indicating each receipt from the transmitter. In this case, the transmitter can be a light transmitter and the receiver can be a receiver to recognize that transmission of light. At each passage of each hole, the receiver records that a light beam has been received. This signal is then transmitted to computer 14 which records that a particular row has passed. In this case, either encoder 29 or optical tracker 31 can be used either separately or together to track the position of each row on a plate.

There is an optional rotating wheel 58 which includes a plurality of rubber paddles. Rotating wheel 58 can be optionally used for assisting in the insertion of the pills or tablets and also for wiping off any unnecessary unwanted material on the tablets.

There is at least one, and there can also be a series or a plurality of printers 50 and associated printer cartridges which may be disposed downstream of the insertion of the elements such as pills or tablets. These printers 50 and/or printer cartridges can be positioned in a staggered manner and can be used to print an inscription on one or all of the tablets or pills.

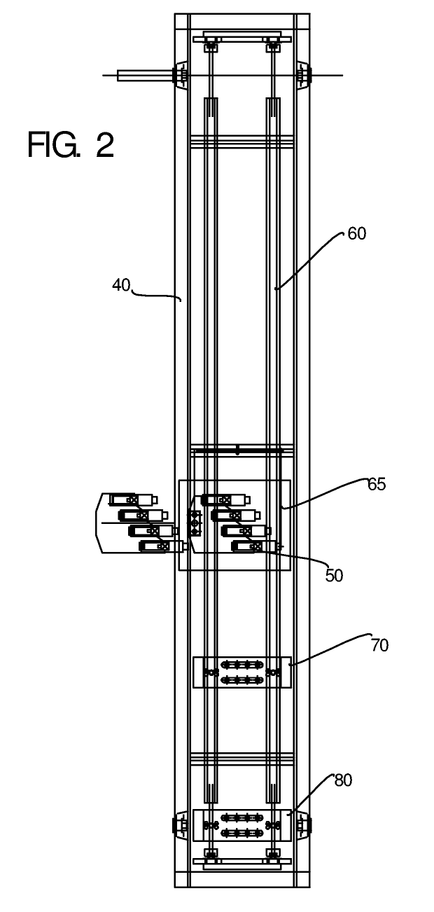

FIG. 2 is a top view of the device wherein this top view shows frame 12, with a conveyor 20 removed. This design shows that there are rails 40 and 60 along frame 12 which are used to support conveyor 20. In addition, there is shown a plurality of printers 50 which are shown in a stacked or staggered position, including four printers 51, 52, 53, 54 which are each in separate communication with computer 14 and can be used to imprint identifying markers or trademarks on the pills or tablets.

There are also a plurality of vacuum or air blowing stations 65, 70 and 80. Each of these blowing stations is coupled to an associated blowing motor (not shown) and is controlled by computer 14. The first station 65 is used to create a suction force on the pills resting on the conveyor. This suction force can be used to reduce any vibration of the pills before, during and shortly after they are printed. This first station is positioned so that it is in a position to be just prior, during and/or just after the printing of the pills. In this position, the pills are pulled into their resting position so that there is no vibration of any of the pills during the printing phase.

In addition, there are at least two additional stages for positioning the blower units. For example, second blower unit 70 is positioned downstream of first blower unit or station 65 and is essentially positioned under first reject station 85. Third blower unit 80 is positioned downstream of second blower unit or station 70 and is positioned under second optional reject station 90.

There can be three optical recognition elements including two electric eyes 103 and 102 and at least one camera 101 which are used to review the effectiveness of the placement and printing of the pills. In this case, a first electric eye 103 is positioned upstream of a second electric eye 102. The first electric eye 103 can be used to determine whether the elements. such as pills or tablets are in their correct position by recognizing the differences in colors between the pills or tablets and the plates on the conveyor. This electric eye can also be used to determine whether the color of that particular tablet or pill is the proper color as well. Signals sent from this electric eye are processed in computer 14. If computer 14 determines whether a tablet has been misplaced on the conveyor, or if the color of a particular tablet is incorrect, then computer 14 signals to a reject station to remove that pill.

Camera 102 can be used to determine whether the printing, or the quality of the printing on each of the pills or tablets was sufficient. In this case, computer 14 has a database of a set of stored images in the form of pixels which form a set of acceptable images which can then be compared to the recognized images on the pills or tablets which are compared to the images in the database. If the images received by the camera are pixelated and then matched using an algorithm, computer 14 will determine that the pills can then pass. If the printing on the pill or the general image of the pill does not match the pixels or the algorithm of the pixels stored in the database of computer 14, then computer 14 will reject that pill and then send instructions to the reject station to have that pill removed.

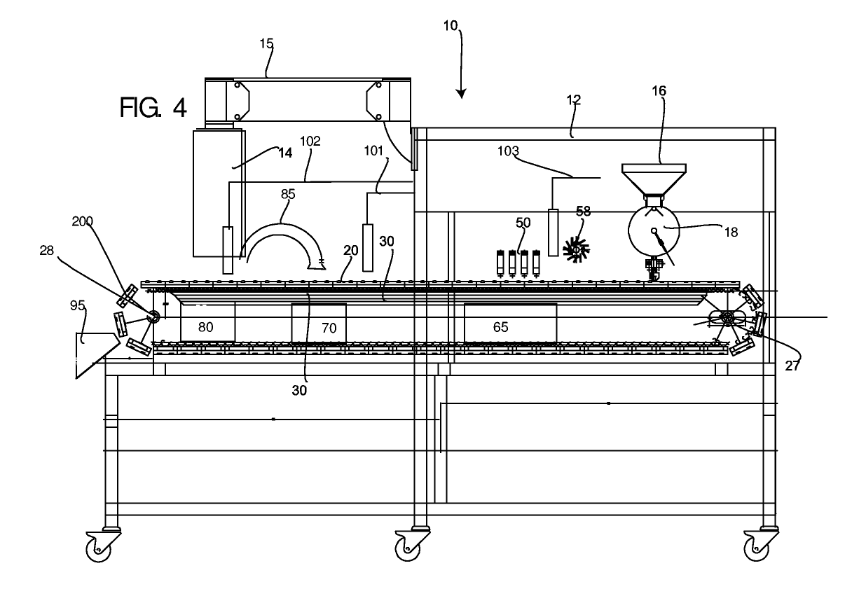

There can also be a reject verification station, which includes an additional electric eye 102 in the form of a color sensor. This color sensor can then be used to determine if the pill or tablet has been properly removed from the conveyor. In the first embodiment, as shown in FIG. 1 there can be a second reject station 90 which can be used to remove a pill or tablet if the reject verification station determines it has not already been removed. In another embodiment as shown in FIG. 4, there is no additional reject station. Therefore, if this second electric eye 102 detects that the pill or tablet in question was removed, then the machine would proceed on. However, if this second electric eye detects that the pill in question remained, then the conveyor would stop and a user could then manually remove the selected pill or tablet.

Once the pills or tablets have passed the reject stations 85 and 90 and camera 101 and electric eye 102, if they have passed inspection, they will be deposited into an end hopper 95 which is an acceptance chute. These pills will then be later distributed into the appropriate packaging.

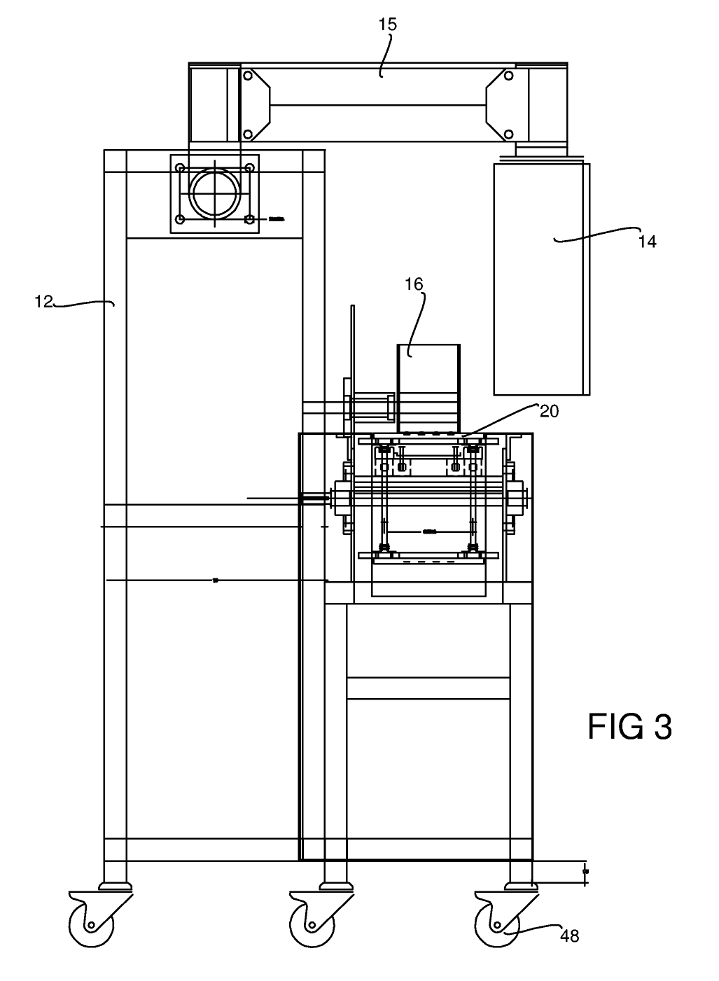

FIG. 3 is an end view of the device which shows computer 14 which can be used to control the additional devices. Computer 14 is coupled to the system on rotating arm 15 and has a front touch screen for control of the different devices. In that way, an operator can stand in any desired position within range of this computer 14 and control the entire device. In this view, there is also shown frame 12 which is coupled to wheels 48, wherein wheels 48 can be used to allow frame 12 to roll around on a factory floor.

FIG. 4 is a side view of another embodiment of the device. In this embodiment, there is no additional reject chute.

FIG. 5A is a top view of a plate 200 that is associated with a conveyor 20. Plate 200 includes a plurality of receptacles or slots 201, 202, 203, 204, 205, 206, 207, 208 wherein each receptacle as shown in FIG. 5E includes an initial receptacle or first receiving region 240 which is sloped down such as in the form of a ramp to a substantially circular receptacle region 242. In the center of each substantially circular receptacle region or second receiving section 242 there is a hole 244 which is used to allow air to be pulled or pushed from an air pump or blower 65, 70, 80 positioned below conveyor plate 200 through that hole.

FIG. 5B is a top perspective view of a plate 200. This view shows that there can also be an additional plate 230 as also shown in FIG. 5C. Additional plate 230 extends beneath top plate 210 and can be in the form of a UHMW, Delrin or plastic style plate that also has an associated plurality of holes 211, 212, 213, and 214 disposed under, and aligned with respective holes in slots or receptacles 201, 202, 203, 204, while the opposite side includes holes 215, 216, 217, and 218 positioned underneath respective holes in slots or receptacles 205, 206, 207, and 208 as shown also in FIG. 5D. Each additional plate 230 extends beneath a top plate 210, wherein each additional plate can be of a different material than the top plate. Thus, while the additional plate 230 may be formed from a relatively frictionless material such as Delrin or UMDW, the top plate 200 can be formed from any other type material such as Teflon® coated metal.

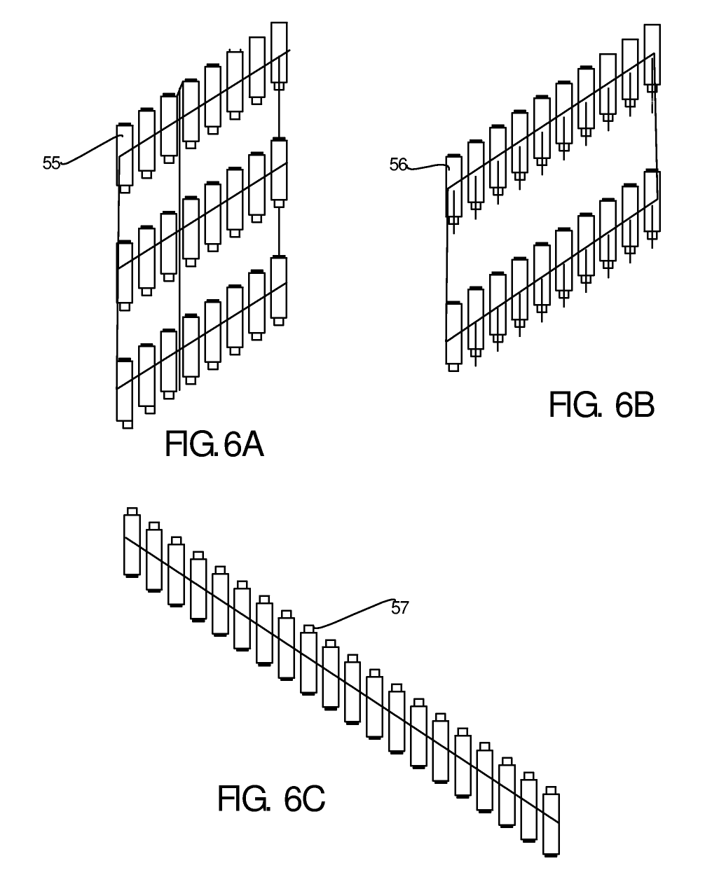

This device can be used with a plurality of different printing setups or use a plurality of different cartridges. For example, FIG. 6A is a top view of a first alternative design of printing 55. In this view, there are a plurality of printers shown with their respective inkjet cartridges set in a staggered three layer array.

With this design, the printers 50 can include easily replaceable printer cartridges for easy refill of the printer toner.

FIG. 6B is a top view of a second alternative design of printers with printing cartridges 56 which includes the different cartridges in a staggered two layer array.

FIG. 6C is a top view of a third alternative design of printers with printing cartridges 57 which includes a single line staggered array of printers and cartridges. With these three designs, it is shown that a plurality of different layouts can be used for creating the staggered printing styles. Each of these printers is controlled by computer 14 and these different types of layouts may be designed to suit any mode of printing. For example, if the conveyor was moving at a very rapid pace, it may be beneficial to have at least two or three tiers of printing stages. Alternatively, if the printing is very complex, a first tier printing stage may be required to apply a first printing coat while a second printing stage may be required to apply a second printing layer or coat of a different color.

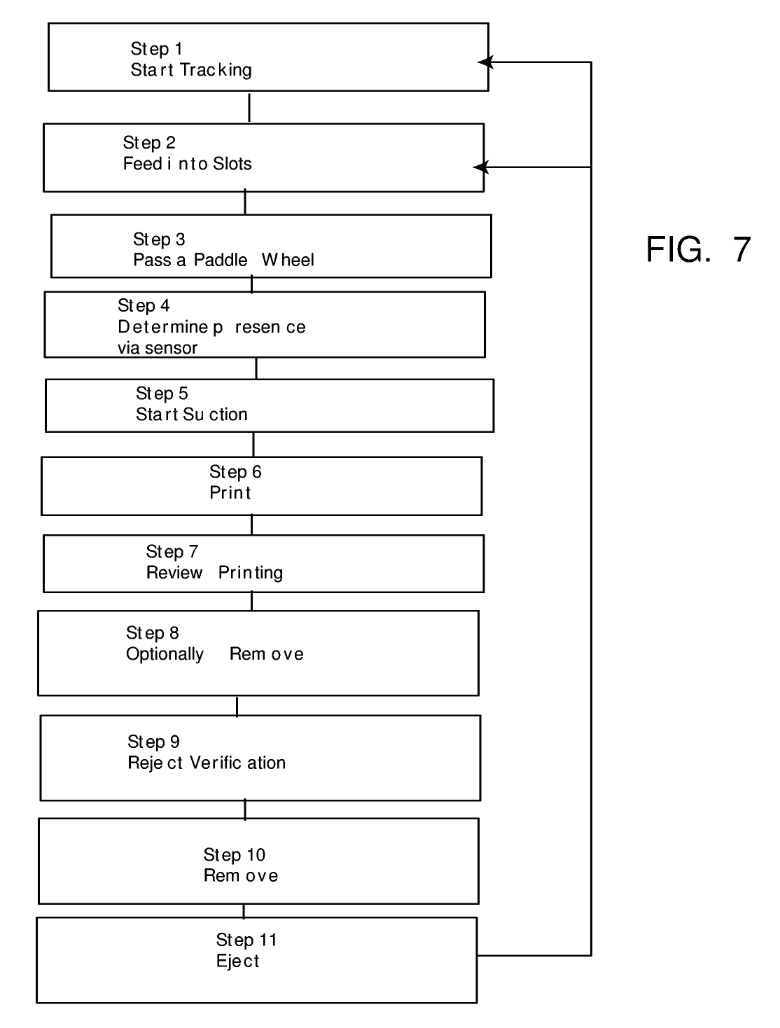

FIG. 7 shows a flow chart for the process for printing these pills. For example, when the machine is in use, unprinted pills, tablets or caplets are fed into a hopper 16. These pills, tablets or caplets may be fed by a vibration feeding machine into hopper 16. They are then fed into a dispenser 18 which may be in the form of a wheel type dispenser or any other known dispenser. However, any known process may be used. Therefore, the process according to the invention starts with a step 1, which involves the start of conveyor 20 which results in the start of the tracking of each row in each plate 200. Next, in step 2, each pill, tablet, or caplet is then fed into the associated slot, such as either into slot 201, 202, 203, 204, 205, 206, 207 or 208 or any other form of slot formed into a top plate 200. In step 3, these pills may then pass an optional paddle 58 which rotates against the direction of the movement of these pills to force these pills into their slots.

During this entire time, step 1 is continuous wherein computer 14 is tracking each slot with the tracking system including conveyor encoder 29, or optical tracker 31 which can be used to track the positioning of each slot or receptacle in each plate. Computer 14 determines this by assigning an identity to each row in the conveyor, wherein the position of each row is then determined by encoder 29 and tracker 31. In step 4, the tracking system and computer 14 can thus be used with color sensors 103 to determine which slot or receptacle may be missing a pill, tablet or caplet. This is because each of the color sensors 103 can be individually encoded to identify each individual slot in the different plates. Thus, computer 14 is constantly tracking the location of each pill, caplet or tablet in each slot which is in a correspondingly tracked row.

For example, at the start of each run, computer 14 can internally record that first row passing optical tracker 31 as row 1. All of the other rows are synchronized or marked based upon this first row. In addition, encoder 29 is started as well and tracks the movement of these rows based upon the revolutions of a particular shaft. In at least one embodiment, one revolution of a sprocket and an associated shaft is calculated as the axial movement of seven plates or 14 rows. This calculation can be optionally synchronized with the readings of optical tracker 31 to determine the exact position of each row at all times. Just before, during, or just after the pills are passing under printers 50, they are placed under a suction force to stabilize the pills to keep them from vibrating. Thus, in step 5, this suction force can extend for numerous rows to provide a stabilizing force for the pills just before, during printing and also if necessary, just after the printing step. The suction force operates on the pills by creating a downward air flow or a negative air pressure on the pills, pulling the pills, caplets, or tablets into each of their respective slots or receptacles thus creating a relatively vibration free environment during the printing stage.

Thus, in step 6, as each tablet, caplet or pill passes an associated printer 50, that printer with instructions from computer 14 prints the associated transcription on a top surface of a pill, tablet or caplet face.

Next, once the pills have been printed, in step 7, they pass a single, or a plurality of an array of cameras 101 for optical review of the printing. For example there can be at least one camera for each of the different slots or receptacles which receive the pills. Therefore, each camera in the array of cameras 101, is designed to recognize an individual pill passing by in each of the respective slots. Because of the tracking system including encoder 29, or visual tracker 31, each camera, can then record the visual image of each pill. This visual image is then pixelated or digitally recorded in computer 14 and then compared to the database of acceptable images. If each of these pills is found acceptable, then they would pass reject station 85 without being rejected.

Otherwise, if one of the cameras in camera array 101 recognizes that a pill has been misprinted, the computer then tracks the location of this pill and then in step 8, instructs an air blower associated with reject station 85 to create a suction force to reject the identified pill or row of pills. In addition, an optional blower 70 can be positioned below reject station 85 to provide additional air pressure, such as in the form of positive air pressure to blow a pill out of its respective slot or receptacle and into reject station 85.

Next, in step 9, as each of the pills pass a rejection confirmation station including an electric eye or a plurality of electric eyes 102, computer 14 records whether that pill has been properly ejected. Because the location of each pill, tablet or caplet has been recorded by computer 14, then any pill identified by an associated camera 101 that is not acceptable, will be continuously tracked both through first reject station 85 and then through reject confirmation station 104, which includes the electric eyes 102. In addition, reject confirmation station 104 includes a light or laser locator which can be used to shine through each of the holes extending through plate 200 and additional plate 230. If this light hits any one of the electric eyes 102, then this indicates that the associated pill is either missing or that it has been purposely removed from the associated slot or receptacle by reject station 85.

If computer 14 determines that a particular tracked slot includes a mis-printed pill, then, at the next station, in step 10, computer 14 can either instruct an additional reject station 90, in step 10 to pull that pill out or, if there is no additional reject station, to stop conveyor 20, and have a user remove the pill.

Finally, in step 11, pills, caplets or tablets can then be sent onto accept chute which then is used to store the pills for later processing. This process continues until all the pills are printed.

In all, the present design creates a system that provides a rapid, efficient printing of tablets or pills using printers that include disposable inkjet cartridges to create a design that is inexpensive to design and install.

Accordingly, while at least one embodiment of the present invention has been shown and described, it is to be understood that many changes and modifications may be made thereunto without departing from the spirit and scope of the invention as defined in the appended claims.

What is claimed is:

1. A device for printing and sorting elements comprising:
a) at least one conveyor for conveying the elements;
b) at least one printer for printing the elements;
c) at least one identifying device for identifying whether each element has been properly printed;
d) at least one reject chute for rejecting an element; and
e) at least one accept chute for accepting an element.

2. The device as in claim 1, further comprising a computer, wherein said computer is in communication with, and is used to control said at least one conveyor, said at least one printer, and said at least one identifying device.

3. The device as in claim 1, wherein the elements are in the form of pills or tablets.

4. The device as in claim 2, wherein said at least one conveyor includes a plurality of holes and wherein the device further comprises at least one air pump to control any movement of the elements on the conveyor.

5. The device as in claim 4, wherein said conveyor includes a plurality of plates, coupled together to form a conveyor line, and wherein each of said plates has a plurality of holes disposed therein, wherein said holes are for receiving the elements therein.

6. The device as in claim 5, wherein said holes form a fluid conduit between a top surface of said conveyor and said air pump, such that said air pump applies a pressure on said elements in said holes, keeping said elements in said holes.

7. The device as in claim 6, further comprising at least one additional air pump for use withdrawing a selected pill from said conveyor.

8. The device as in claim 7, wherein said at least one additional air pump comprises at least two additional pumps, wherein at least one first additional air pump is for pushing said element out from an associated hole and at least one second additional air pump is for pulling that element into said reject chute.

9. The device as in claim 1, wherein said at least one identifying device is in the form of an electric eye.

10. The device as in claim 1, wherein said at least one identifying device is in the form of a camera.

11. The device as in claim 1, wherein said at least one printer is in the form of an inkjet printer.

12. The device as in claim 11, wherein said at least one printer is in the form of at least four inkjet printers positioned in a staggered manner.

13. The device as in claim 11, wherein each of said at least one printer includes at least one removable ink cartridge.

14. The device as in claim 5, wherein each of said plurality of plates includes a plurality of holes with at least one hole for receiving at least one element, and at least one hole for fastening said plate to an underlying conveyor.

15. The device as in claim 5, wherein said plurality of plates include at least one receiving section, for receiving the elements, wherein said at least one receiving section extends into and includes at least one of said holes.

16. The device as in claim 1, wherein said at least one receiving section is in the form of a first receiving section, and a second receiving section, wherein said first receiving section is sloped down, to initially receive the element and said second receiving section is adapted to retain the element in place.

17. The device as in claim 16, wherein said first receiving section is in the form of a ramp shaped section and said second receiving section is in the form of a substantially circular indent having a hole disposed in a substantially central region.
